(19) United States
(12) Patent Application Publication
(10) Pub. No.: US 2008/0131004 A1
(43) Pub. Date: Jun. 5, 2008

(54) System or method for segmenting images

(76) Inventors: Michael E. Farmer, Independence Township, MI (US); Xunchang Chen, Ann Arbor, MI (US); Li Wen, Rochester, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/619,035

(22) Filed: Jul. 14, 2003

(51) Int. Cl. G06K 9/62

(52) U.S. Cl. 382/224

(57) ABSTRACT

The disclosed system identifies the images of particular objects or organisms (“segmented image” or “target image”) from images that include the segmented image and the surrounding area (collectively, the “ambient image”). Instead of attempting to merely segment the target image from the ambient image, the system purposely “over-segments” the ambient image into various image regions. Those image regions are then selectively combined into the segmented image using a predefined heuristic that incorporates logic relating to the particular context of the processed image. In some embodiments, different combinations of image regions are evaluated on the basis of probability-weighted classifications.

### BACKGROUND OF THE INVENTION

The present invention relates in general to a system or method (collectively “segmentation system” or simply “system”) for isolating a segmented or target image from an image that includes the target image and an area surrounding the target image (collectively the “ambient image”). More specifically, the invention relates to segmentation systems that identify various image regions within the ambient image and then combine the appropriate subset of image regions to create the segmented image.

Computer hardware and software are increasingly being applied to new types of applications. Programmable logic devices (“PLDs”) and other forms of embedded computers are increasingly being used to automate a wide range of different processes. Many of those processes involve the capturing of sensor images, and using information in the captured images to invoke some type of automated response. For example, a safety restraint application in an automobile may utilize information obtained about the position and classification of a vehicle occupant to determine whether the occupant would be too close to the airbag at the time of deployment for the airbag to safely deploy. Another category of automated image-based processing would be various forms of surveillance applications that need to distinguish human beings from other forms of animals or even animate and inanimate objects.

In contrast to automated applications, the human mind is remarkably adept at differentiating between different objects in a particular image. For example, a human observer can easily distinguish between a person inside a car and the interior of a car, or between a plane flying through a cloud and the cloud itself. The human mind can perform image segmentation correctly even in instances where the quality of the image being processed is blurry or otherwise imperfect. In contrast, imaging technology is increasingly adept at capturing clear and detailed images. Imaging technology can be used to capture images that cannot be seen by human beings, such as non-visible light. However, segmentation technology is not keeping up with the advances in imaging technology or computer technology and current segmentation technology is not nearly as versatile and accurate as the human mind. With respect to many different applications, segmentation technology is the weak link in an automated process that begins with the capture of an image and ends with an automated response that is selectively determined by the particular characteristics of the captured image. Put in simple terms, computers are not adept at distinguishing between the target image or segmented image needed by the particular application, and the other objects or entities in the ambient image which constitute “clutter” for the purposes of the application requiring the target image. This problem is particularly pronounced when the shape of the target image is complex, such as a human being free to move in three-dimensional space, being photographed by a single stationary sensor.

Conventional segmentation technologies typically take one of two approaches. One category of approaches (“edge/contour approaches”) focuses on detecting the edge or contour of the target object to identify motion. A second category of approaches (“region-based approaches”) attempts to distinguish various regions of the ambient image in order to identify the segmented image. The goal of these approaches is neither to divide the segmented image into smaller regions (“over-segment the target”) nor to include what is background into the segmented image (“under-segment the target”). Without additional contextual information, which is what helps a human being make such accurate distinctions, the effectiveness of either category of approaches is limited.

One way to integrate contextual information into the segmentation process is to integrate classification technology into the segmentation process. Such an approach can involve purposely over-segmenting the target, and then using contextual information to determine how to assemble the various “pieces” of the target into the segmented image. Neither the integration of image classification into the segmentation process nor the purposeful over-segmentation of the ambient image is taught or even suggested by the existing art.

### SUMMARY OF THE INVENTION

The present invention relates in general to a system or method (collectively the “system”) for identifying an image of a target (the “segmented image”) from within an image that includes the target and the surrounding area (the “ambient image”). More specifically, the invention relates to systems that identify a segmented image from the ambient image by breaking down the ambient image into various image regions, and then selectively combining some of the image regions into the segmented image.

In some embodiments of the system, a segmentation subsystem is used to identify various image regions within the ambient image. A classification subsystem is then invoked to combine some of the image regions into a segmented image of the target. In a preferred embodiment, the classification subsystem uses contextual information relating to the application to assist in selectively identifying image regions to be combined. For example, if the target image is known to be one of a finite number of classes, probability-weighted classifications can be incorporated into the process of combining image regions in the segmented image.

In some embodiments, a pixel analysis heuristic is used to analyze the pixels of the ambient image to identify various image regions. A region analysis heuristic can then be used to selectively combine some of the various image regions into a segmented image. An image analysis heuristic can then be invoked to obtain image classification and image characteristic information for the application using the information from the segmented image.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a process flow diagram illustrating an example of a process beginning with the capture of an image from an image source and ending with the capture of image characteristics and an image classification from a segmented image.

FIG. 2 is a hierarchy diagram illustrating an example of a image hierarchy including various image regions, with the various image regions including various pixels.

FIG. 3 is a hierarchy diagram illustrating an example of a pixel-level, region-level, image-level and application-level processing.

FIG. 4a is block diagram illustrating an example of a subsystem-level view of the system.

FIG. 4b is a block diagram illustrating another example of a subsystem-level view of the system.

FIG. 5 is a flow chart illustrating one example of a process flow that can be incorporated into the system.

FIG. 6 is a flow chart illustrating another example of a process flow that can be incorporated into the system.

FIG. 7 is a diagram illustrating one example of a captured ambient image that has not yet been subjected to any subsequent processing.

FIG. 8 is a diagram illustrating one example of an ambient image after a region of interest analysis has removed certain portions of the ambient image.

FIG. 9 is a histogram illustrating one example of how the pixels of the initially captured ambient image can be analyzed.

FIG. 10 is a graph illustrating various example of Gaussian distributions used to identify the various image regions in the ambient image.

FIG. 11 is a graph illustrating one example of the results of an expectation-maximization heuristic.

FIG. 12 is a diagram illustrating an example of an ambient image that has been subjected to region of interest processing.

FIG. 13 is diagram illustrating an example of an ambient image that is divided into various image regions.

FIG. 14 is a diagram illustrating an example of various image regions subject to a noise filter.

FIG. 15 is a chart illustrating an example of a region location definition.

FIG. 16 is a block diagram illustrating an example of a k-NN heuristic.

FIG. 17 is an example of a classification-distance graph.

### DETAILED DESCRIPTION

The present invention relates in general to a system or method (collectively the “system”) for identifying an image of a target (the “segmented image” or “target image”) from within an image that includes the target and the surrounding area (the “ambient image”). More specifically, the system identifies a segmented image from the ambient image by breaking down the ambient image into various image regions. The system then selectively combines some of the image regions into the segmented image.

### I. Introduction of Elements

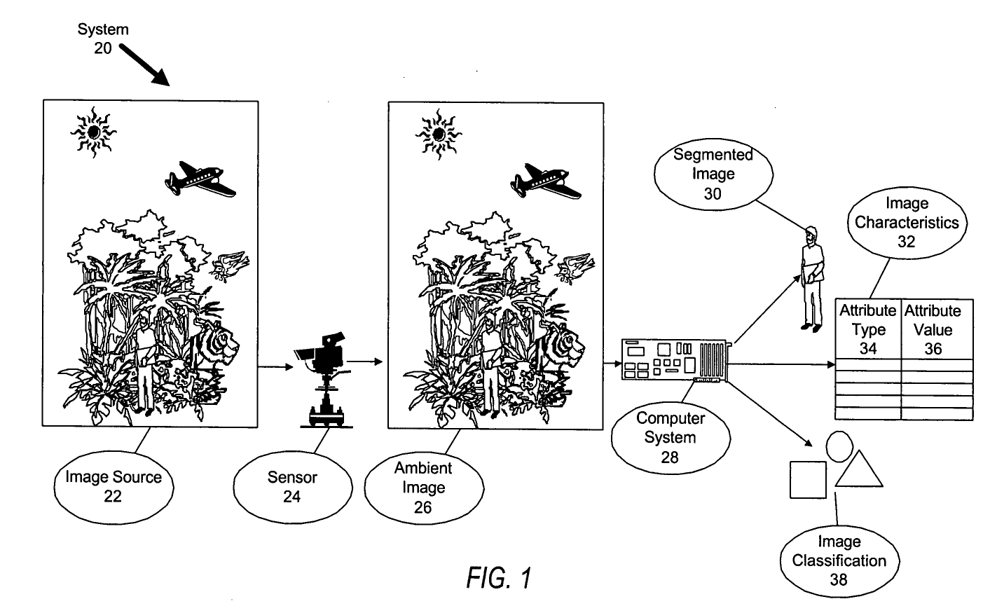

FIG. 1 is a process flow diagram illustrating an example of a process performed by a segmentation system (the “system”) 20 beginning with the capture of an ambient image 26 from an image source 22 with a sensor 24 and ending with the identification of a segmented image 30, along with image characteristics 32 and an image classification 38.

A. Image Source

The image source 22 is potentially anything that a sensor 24 can capture in the form of some type of image. Any individual or combination of persons, animals, plants, objects, spatial areas, or other aspects of interest can be image sources 22 for data capture by one or more sensors 24. The image source 22 can itself be an image or a representation of something else. The contents of the image source 22 need not physically exist. For example, the contents of the image source 22 could be computer generated special effects. In an embodiment of the system 20 that involves a safety restraint application used in a vehicle, the image source 22 is the occupant of the vehicle and the area in the vehicle surrounding the occupant. Unnecessary deployments and inappropriate failures to deploy can be avoided by the access of an airbag deployment application to accurate occupant classifications.

In other embodiments of the system 20, the image source 22 may be a human being (various security embodiments), persons and objects outside of a vehicle (various external vehicle sensor embodiments), air or water in a particular area (various environmental detection embodiments), or some other type of image source 22.

B. Sensor

The sensor 24 is any device capable of capturing the ambient image 26 from the image source 22. The ambient image 26 can be at virtually any wavelength of light or other form of medium capable of being captured in the form of an image, such as a ultrasound “image.” The different types of sensors 24 can vary widely in different embodiments of the system 20. In a vehicle safety restraint application embodiment, the sensor 24 may be a standard or high-speed video camera. In a preferred embodiment, the sensor 24 should be capable of capturing images fairly rapidly, because the various heuristics used by the system 20 can evaluate the differences between the various sequence or series of images to assist in the segmentation process. In some embodiments of the system 20, multiple sensors 24 can be used to capture different aspects of the same image source 22. For example, in a safety restraint embodiment, one sensor 24 could be used to capture a side image while a second sensor 24 could be used to capture a front image, providing direct three-dimensional coverage of the occupant area.

The variety of different types of sensors 24 can vary as widely as the different types of physical phenomenon and human sensation. Some sensors 24 are optical sensors, sensors 24 that capture optical images of light at various wavelengths, such as infrared light, ultraviolet light, x-rays, gamma rays, light visible to the human eye (“visible light”), and other optical images. In many embodiments, the sensor 24 may be a video camera. In a preferred airbag embodiment, the sensor 24 is a video camera.

Other types of sensors 24 focus on different types of information, such as sound (“noise sensors”), smell (“smell sensors”), touch (“touch sensors”), or taste (“taste sensors”). Sensors can also target the attributes of a wide variety of different physical phenomenon such as weight (“weight sensors”), voltage (“voltage sensors”), current (“current sensor”), and other physical phenomenon (collectively “phenomenon sensors”). Sensors 24 that are not image-based can still be used to generate an ambient image 26 of a particular phenomenon or situation.

C. Ambient Image

The ambient image 26 is any image captured by the sensor 24 for which the system 20 desires to identify the segmented image 30. Some of the characteristics of the ambient image 26 are determined by the characteristics of the sensor 24. For example, the markings in an ambient image 26 captured by an infrared camera will represent different target or source characteristics than the ambient image 26 captured by a ultrasound device. The sensor 24 need not be light-based in order to capture the ambient image 26, as is evidenced by the ultrasound example mentioned above.

In some embodiments, the ambient image 26 is a digitally captured image, in other embodiments it is an analog captured image that has subsequently been converted to a digital image to facilitate automatic processing by a computer. The ambient image 26 can also vary in terms of color (black and white, grayscale, 8-color, 16-color, etc.) as well as in terms of the number of pixels and other image characteristics.

In a preferred embodiment of the system 20, a series or sequence of ambient images 26 are captured. The system 20 can be aided in image segmentation if different snapshots of the image source 22 are captured over time. For example, the various ambient images 26 captured by a video camera can be compared with each other to see if a particular portion of the ambient image 26 is animate or inanimate.

D. Computer System or Computer

In order for the system 20 to perform the various heuristics described below in a real time or substantially real-time manner, the system 20 can incorporate a wide variety of different computational devices, such as programmable logic devices (PLDs), embedded computers, or other form of computation devices (collectively a “computer system” or simply a “computer” 28). In many embodiments, the same computer system 20 used to segment the target image 30 from the ambient image 26 is also used to perform the application processing that uses the segmented image 30. For example, in a vehicle safety restraint embodiment such as an airbag deployment application, the computer system 20 used to identify the segmented image 30 from the ambient image 26 can also be used to determine: (1) the kinetic energy of the human occupant needed to be absorbed by the airbag upon impact with the human occupant, (2) whether or not the human occupant will be too close (the “at-risk-zone”) to the deploying airbag at the time of deployment; (3) whether or not the movement of the occupant is consistent with a vehicle crash having occurred; (4) the type of occupant, such as adult, child, rear-facing child seat, etc.

E. Segmented Image or Target Image

The segmented image 30 is any part of the ambient image 26 that is used by some type of application for subsequent processing. In other words, the segmented image 30 is the part of the ambient image 26 that is relevant to the purposes of the application using the system 20. Thus, the types of segmented images 30 identified by the system 20 will depend on the types of applications using the system 20 to segment images. In a vehicle safety restraint embodiment, the segmented image 30 is the image of the occupant, or at least the upper torso portion of the occupant. In other embodiments of the system 20, the segmented image 30 can be any area of importance in the ambient image 26.

The segmented image 30 can also be referred to as the “target image” because the segmented image 30 is the reason why the system 20 is being utilized by the particular application. The segmented image 30 is the target or purpose of the application invoking the system 20.

G. Image Characteristics

The segmented image 30 is useful to applications interfacing with the system 20 because certain image characteristics 32 can be obtained from the segmented image 30. Image characteristics can include a wide variety of attribute types 34, such as color, height, width, luminosity, area, etc. and attribute values 36 represent the particular trait of the segmented image 30 with respect to the particular attribute type 34. Examples of attribute values 36 can include blue, 20 pixels, 0.3 inches, etc. In addition to being derived from the segmented image 30, expectations with respect to image characteristics 32 can be used to help determine the proper scope of the segmented image 30 within the ambient image 26. This “boot strapping” approach is described in greater detail below, and is a way of applying some application-related context to the segmentation process implemented by the system 20.

Image characteristics 32 can also be statistical data relating to an image or a even a sequence of images. For example, the image characteristic 32 of image constancy, discussed in greater detail below, can be used to assist in the process of whether a particular portion of the ambient image 26 should be included as part of the segmented image 30.

In a vehicle safety restraint embodiment of the system 20, the segmented image 30 of the vehicle occupant can include characteristics such as relative location with respect to an at-risk-zone within the vehicle, the location and shape of the upper torso, or a classification as to the type of occupant.

H. Image Classification

In addition to various image characteristics 32, the segmented image 30 can also be categorized as belonging to one or more image classifications 38. For example, in a vehicle safety restraint application, the segmented image 30 could be classified as an adult, a child, a rear facing child seat, etc. in order to determine whether an airbag should be precluded from deployment on the basis of the type of occupant. In addition to being derived from the segmented image 30, expectations with respect to image classification 38 can be used to help determine the proper boundaries of the segmented image 30 within the ambient image 26. This “boot strapping” process is described in greater detail below, and is a way of applying some application-related context to the segmentation process implemented by the system 20. Image classifications 38 can be generated in a probability-weighted fashion. The process of selectively combining image regions into the segmented image 30 can make distinctions based on those probability values.

### II. Hierarchy of Image Elements

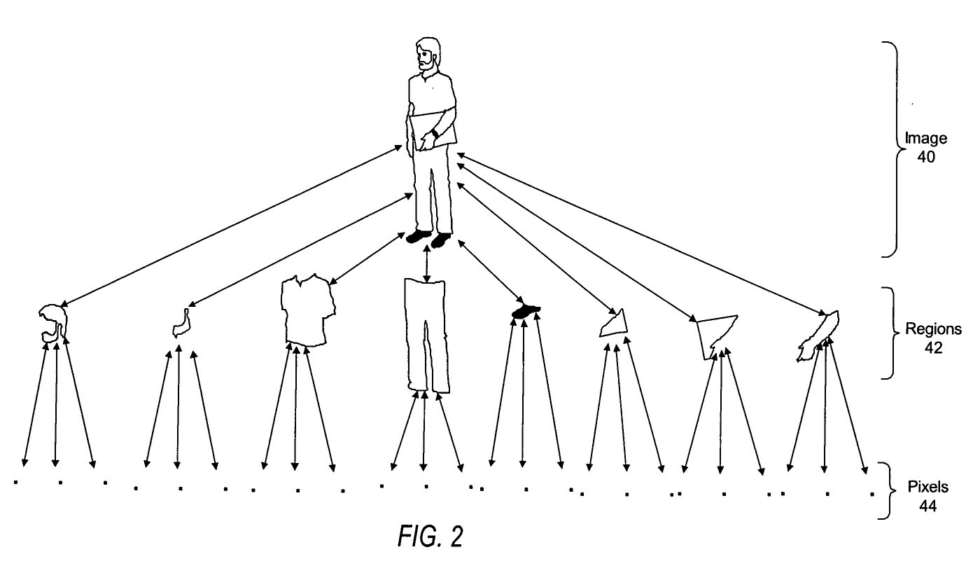

FIG. 2 is a hierarchy diagram illustrating an example of an image hierarchy. At the top of the image hierarchy is an image 40. The image 40 is made up of various image regions (“regions”) 42. In turn the regions 42 are made up of pixels 44.

A. Images

The hierarchy of images can apply to any type of image 40, whether the image is the ambient image 26, the segmented image 30, or some form of image that is being processed by the system 20 and is between the original state of being the ambient image 26 but is not yet the segmented image 30. All images 40, including the ambient image 26, the segmented 30, and various images in the state of being processed by the system 20, can be “broken down” into various regions 42.

B. Image Regions

Image regions or simply “regions” 42 can be identified based on shared pixel characteristics relevant to the purpose of the application invoking the system 20. Thus, regions 42 can be based on color, height, width, area, texture, luminosity, or potentially any other relevant pixel characteristic. In embodiments for series of ambient images 26 and targets that move in an environment that is generally non-moving, regions 42 are preferably based on constancy or consistency. Regions 42 of the ambient image 26 that are the same over many image frames are probably background regions 42 and can either be ignored or can be given a low probability of being part of the desired object in the subsequent region combining processing. These subsequent processing stages are described in greater detail below.

In some embodiments, regions 42 can themselves be broken down into other regions 42 (“sub-regions”). Sub-regions could themselves be made up of small sub-regions. Ultimately, images 40 and regions 42 break down into some form of fundamental “atomic” unit. In many embodiments, this fundamental unit is referred to as pixels 44.

C. Pixels

A pixel 44 is an indivisible part of one or more regions 42 within the image 40. The number of pixels 44 in the sensor 24 determine the limits of detail that the particular sensor 24 can capture. Just as images 40 can be associated with image characteristics 32, pixels 44 can be associated with pixel characteristics, such as color, luminosity, constancy, etc.

### III. Processing-Level View

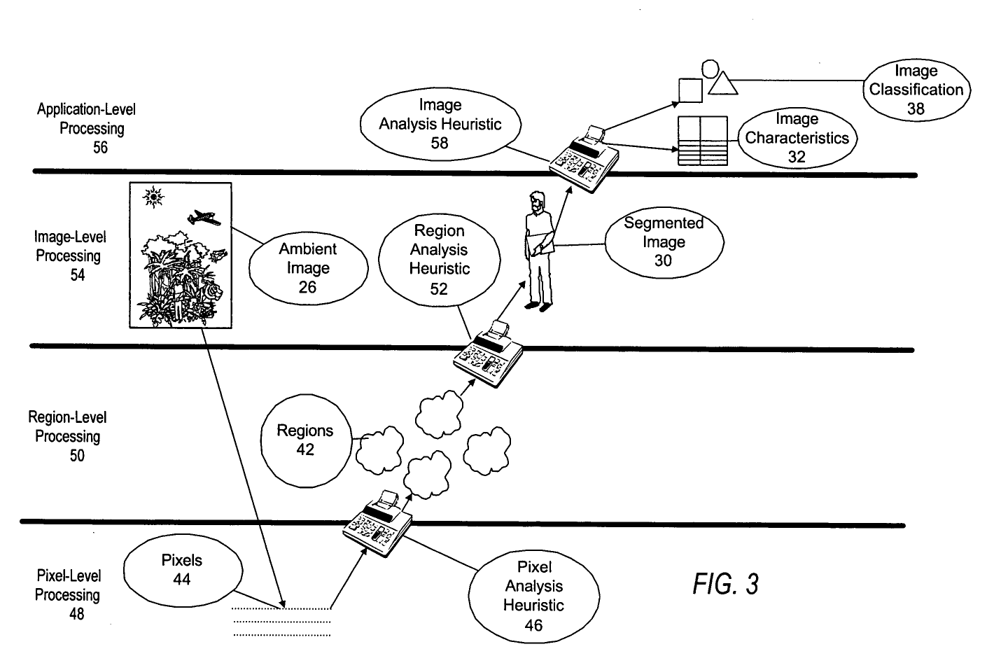

FIG. 3 is a hierarchy diagram illustrating an example of a pixel-level, region-level, image-level and application-level processing. As illustrated in the figure, the system 20 performs processing from left to right, at various layers of data. The system 20 begins with image-level processing 54 by the capture of the ambient image 26 as is also illustrated in FIG. 1.

A. Pixel-Level Processing.

That ambient image 26 of FIG. 3 is then evaluated by the system 20 through the use of pixel-level processing 48. A wide variety of different pixel analysis heuristics 46 can be used to organize and categorize the various pixels 44 in the ambient image 26 into various regions 42 for region-level processing 50. Different embodiments may use different pixel characteristics or combinations of pixel characteristics to perform pixel-level processing 48.

B. Region-Level Processing

A wide variety of region analysis heuristics 52 can be used to combine a selective subset of regions 42 into the segmented image 30 for image-level processing 54. These processes are described in greater detail below. Various predefined combination rules can be selectively invoked by the system 20. The region analysis heuristic 52 can also be referred to as a predefined combination heuristic because the particular process is predefined in light of the particular application using the system 20.

C. Image-Level Processing

The segmented image 30 can then be processed by an image analysis heuristic 58 to identify image classification 38 and image characteristics 32 as part of application-level processing 56. Image-level processing typically marks the border between the system 20, and the application or applications invoking the system 20. The nature of the application should have an impact on the type of image characteristics 32 passed to the application. The system 20 need not have any cognizance of exactly what is being done during application-level processing 56.

D. Application-Level Processing

In an embodiment of the system 20 invoked by a vehicle safety restraint application, image characteristics 32 and image classifications 38 can be used to preclude airbag deployments when it would not be desirable for those deployments to occur, invoke deployment of an airbag when it would be desirable for the deployment to occur, and to modify the deployment of the airbag when it would be desirable for the airbag to deploy, but in a modified fashion. Application-level processing 56 may include one or more image analysis heuristics 58, such as the use of multiple probability-weighted Kalman filter models for various motion and shape states.

### IV. Subsystem-Level View

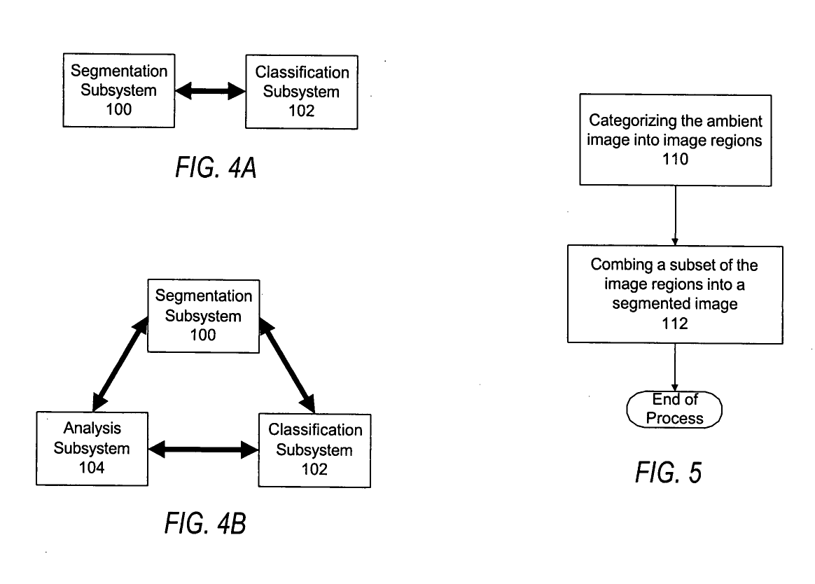

FIG. 4a is block diagram illustrating an example of a subsystem-level view of the system 20.

A. Segmentation Subsystem

A segmentation subsystem 100 is the part of the system 20 that breaks down the image 40 into regions 42. This is typically done by performing the pixel analysis heuristic 46 on the pixels 44 of the ambient image 26 or some version of the ambient image (collectively, the “ambient image” 26) that has already begun to be processed by the system 20. The segmentation subsystem 100 provides for the identification of the various image regions 42 within the ambient image 26. The segmentation subsystem 100 can also be referred to as a “break down” subsystem or “deconstruction” subsystem because it involves breaking down or deconstructing the image 40 into smaller pieces such as regions 42 by looking at pixel 44 related characteristics.

In some preferred embodiments, a region-of-interest analysis is performed after the capture of the ambient image 26 but before the processing of the segmentation subsystem 100. Pixels 44 that are identified as not being of interest can be removed before the break down process of the segmentation process is performed in order to speed up the processing time for real-time applications. The region-of-interest analysis is described in greater detail below.

In some embodiments, an “exterior first” heuristic is performed to remove subsets of pixels 44 or regions 42 on the basis of the relative locations of the pixels 44 or regions 42 with respect to the interior or exterior portions of the image 40. The “exterior first” heuristic is described in greater detail below. The “exterior first” heuristic can be said to be invoked by either the segmentation subsystem 100 or a classification subsystem 102.

B. Classification Subsystem

A classification subsystem 102 can also be referred to as a “combination” subsystem or a “build-up” subsystem because it performs the function of selectively combining certain image regions 42 to form the segmented image 30.

Some image regions 42 can be excluded from consideration on the basis of their size (in pixels 44). For example, all image regions 42 that are smaller in area than a predefined size threshold can be excluded. The types of assumptions and contextual information that can be incorporated into the classification subsystem 102 in constructing segmented images 30 from image regions 42 are discussed in greater detail below.

Just as image characteristics 32 can include attribute types 34 and attribute values 36, the pixel characteristics and region characteristics can be processed in the form of attribute types 34 and attribute values 36. Region characteristics and pixel characteristics can be incorporated into the predefined combination rules used by the classification subsystem 102 to determine which regions 42 should be combined into the segmented image 30.

C. Analysis Subsystem

FIG. 4b is a block diagram illustrating another example of subsystem-level view of the system 20. The only difference between FIG. 4a and FIG. 4b is the presence of an analysis subsystem 104. The analysis subsystem 104 is responsible for performing application-level processing 56. Image characteristics 32 and image classifications 36 are some of the potential outputs of the analysis subsystem 104.

In some embodiments, processing performed by the analysis subsystem 104 is incorporated into the segmentation subsystem 100 and classification subsystem 102 to enhance the accuracy of those subsystems. For example, if the analysis subsystem 20 has already determined that a large adult is sitting in a position before the airbag deployment application, and the vehicle has not stopped moving since that determination, the knowledge that the segmented image 30 is a large adult occupant can alter the way in which the segmentation subsystem 100 and classification subsystem 102 weigh various tradeoffs.

### V. High-Level Process Flow

FIG. 5 is a flow chart illustrating one example of a process flow that can be incorporated into the system 20.

The system 20 categorizes the ambient image 26 into image regions 42 at 110. A subset of image regions 42 are then combined into the segmented image 30 at 112.

### VI. Detailed Process Flow

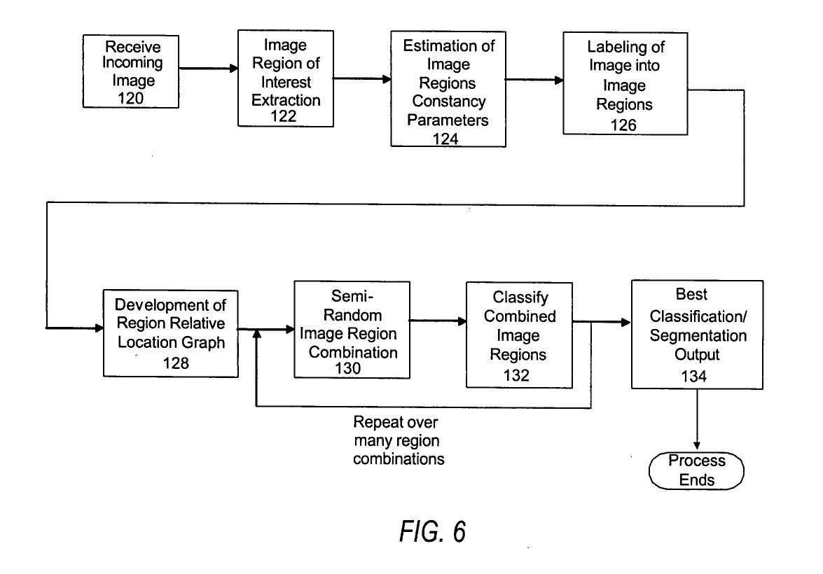

FIG. 6 is a flow chart illustrating another example of a process flow that can be incorporated into the system 20.

A. Receive Incoming Image

At 120, the system 20 receives an incoming ambient image 26. This step is preferably performed with each incoming ambient image 26 in a real-time or substantially real-time manner. In a vehicle safety restraint application embodiment, the system 20 should be receiving and processing numerous ambient images 26 each second.

B. Region of Interest Extraction

At 122, the system 20 performs a region of interest heuristic. In many image processing applications the sensor captures an ambient image 26 which extends beyond the area in which a possible target or segmented image 30 may appear. For example in a video surveillance system the camera usually sees areas of the walls in a hallway as well as the hallway. In a vehicle safety restraint application, the portion of the interior that is to the rear of the seat corresponding to the airbag is not relevant to the deployment of the airbag. Moreover, the sensor camera may see portions of the dash board and the rear seat where no occupant may be located These regions of never changing imagery can be ignored by the system 20 since no relevant object or target can be located there.

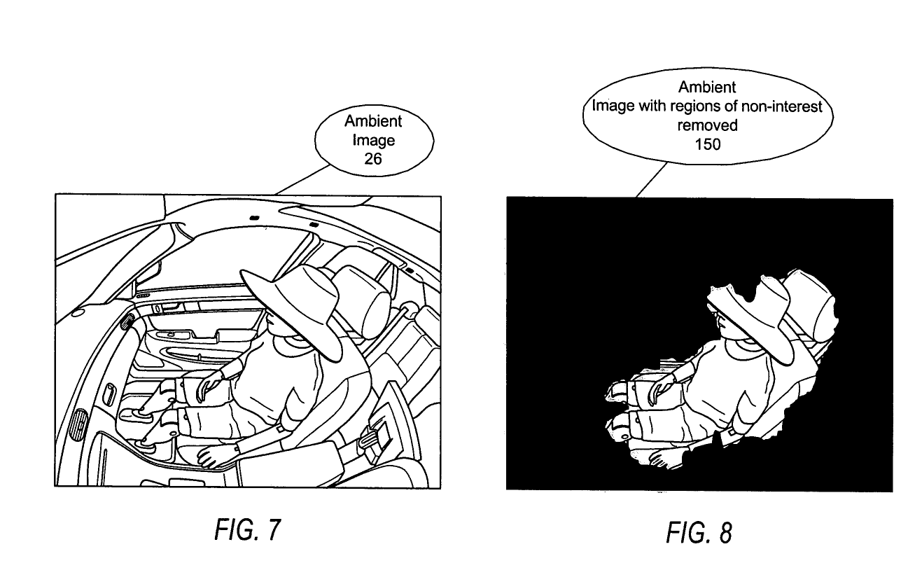

FIG. 7 is a diagram illustrating one example of a captured ambient image 26 that has not yet been subjected to any subsequent region of interest processing. FIG. 8 is a diagram illustrating one example of a modified ambient image 150. FIG. 7 is an example of an input for region of interest processing. The image in FIG. 8 is a corresponding example of an output for region of interest processing. Portions of the ambient image 26 that are not within the region of interest are preferably removed with respect to subsequent processing. The degree to which the region of interest limits the scope of subsequent processing should be configured to the context of the particular application invoking the system 20.

There are many potential methods for accomplishing region of interest processing. Even in applications where the field of sensor measurement is well matched to the problem, some pre-processing of regions of constancy can be discarded to reduce the number of image regions 42 that must be processed in the final stages of the system 20.

C. Estimation of Constancy Parameters

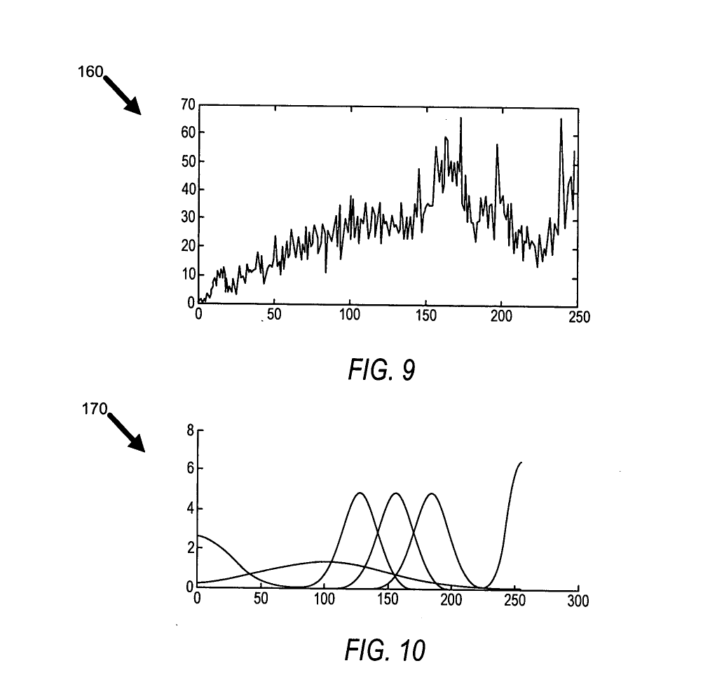

Returning now to FIG. 6, constancy parameters are estimated at 124. This stage of the processing calculates the values for the parameters of constancy. These parameters may be characteristics such as color, texture, greyscale value, etc. depending on the application using the system 20 to segment target images 30. An example of an incoming histogram 160 of pixel parameters is disclosed in FIG. 9.

One preferred method is to use an expectation-maximization (EM) heuristic for estimating these values. The EM heuristic is a type of pixel analysis heuristic 46 that assumes that images are comprised of some mixture of Gaussian distributions, where the distributions may be multi-dimensional to include texture and greyscale or color and intensity or any other possible combination of parameters. The EM heuristic is given a number of Gaussian distributions and some random initial set of parameter values. The initial set of parameter values are preferably equally spaced across the greyscale distribution and the variances all set to unity. An example of such an initially tailored configuration of Gaussian distributions is disclosed in a graph 170 in FIG. 10. The EM heuristic then determines the best possible combination of distributions for the image 40.

One challenge with the EM heuristic is that it can find local maxima rather than global ones, which means the final solution is not necessarily optimal. Thus, it is often desirable to tailor the initial conditions to the specific context of the application utilizing the system 20.

For a vehicle safety restraint application embodiment of the system 20, the processing of video camera images 40 should incorporate a logarithmic amplitude response to help with the outdoor image dynamic range conditions. Consequently, the system 20 preferably spaces the initial means in a pattern that has a concentration of distributions at the higher amplitudes to provide adequate separation of regions 42 in the imagery 40.

Another challenge faced by pixel analysis heuristics 46 is that for larger images, there can be an infinite number of possible underlying histograms 160, so it is difficult to get reliable decomposition data, such as EM decomposition. To alleviate this obstacle, it is preferable to divide the image 40 into a mosaic of image regions 42 and separately process each region 42.

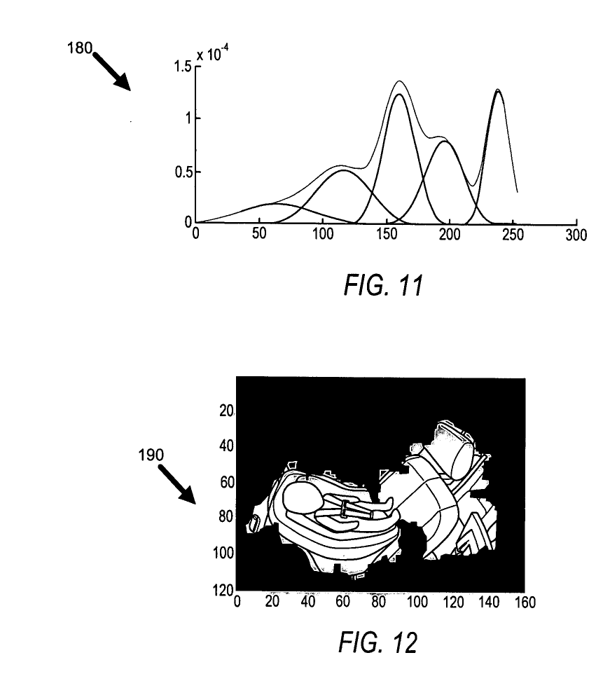

A significantly uniform distributed histogram of the whole image 40 tends to show structure at the smaller region level. This structure allows the EM heuristic to more reliably converge to a global maxima. FIG. 11 discloses a graph 180 representing a final EM solution.

D. Labeling of Image Regions

Returning to FIG. 6, the various groupings of pixels 44 are labeled at 126, as image regions 42 in accordance with the estimated constancy parameters. The step in the process results in various pixels 44 in the image 40 being associated into groups of image regions 42 on the basis of the pixel parameters.

Once the parameters for the distributions have been defined at 124, each pixel 44 in the image 40 is labeled as to the distribution from which it most likely was generated. For example each pixel 44 that was 0-255 (for greyscale imagery) is now mapped to values between 1 and N where N is the number of distributions (typically 5-7 mixtures has worked well for many types of imagery).

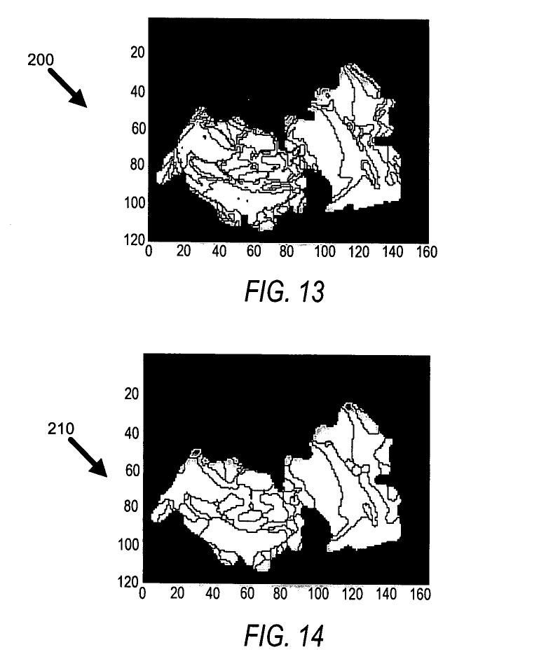

A region-of-interest image 190 in FIG. 12 shows an ambient image 26 that has been processed for region-of-interest extraction at 122 but before image region labeling at 126. A pseudo-colored image 200 that includes a first iteration of image region 42 labeling is disclosed in FIG. 13. The particular pseudo-colored image 200 in FIG. 13 was labeled and defined by the estimated EM mixture heuristic.

In order to reduce the noisiness of the resultant labeling, the pseudo-colored image 200 of FIG. 13 is preferably passed through some type of filter. In many embodiments, the filter can be referred to as a mode filter. The filter performs a histogram within a M×M window around each pixel 44 and replaces the pixel 44 with a parameter value that corresponds to the peak of the histogram (e.g. the mode). A filtered image 210 in FIG. 14 shows the results of the Mode-filter operation. There are many other possible methods for the Mode-filtering, for example Markov Random Fields, annealing, relaxation, and other methods, however most of these require considerably more processing and have not been found to provide dramatically different results.

Once the pixels 44 have been labeled and smoothed with the Mode filter, a combination heuristic is run on the image 210. This heuristic groups all of the commonly labeled pixels 44 that happen to be adjacent to each other and assigns a common region ID to them. At the completion of this stage, all of the pixels 44 in the filtered image 210 are grouped into regions 42 of varying sizes and shapes and these regions 42 correspond to the regions 42 in the “constancy” or parameterized image created at 122.

In a preferred embodiment, regions 42 that are below a predefined size threshold are dropped from the image 210. This reduces the number of regions 42 and since they are small in area they tend to contribute little in the overall description of the shape of the target, such as a vehicle occupant in a safety restraint embodiment of the system 20. For each region 42, a data structure should be stored that includes information relating to the centroid location of the region 42, its maximum and minimum location in the X and Y direction in the image, the number of pixels 44 in the region 42, and any other possible parameter that may aid in future combinations such as some measure of region 42 shape complexity, etc.

E. Development of Region Relative Location Graph

Returning to FIG. 6, the system 20 creates a map, graph, or some other form of data structure that correlates the various image regions 42 to their relative locations in the ambient image 26 at 128.

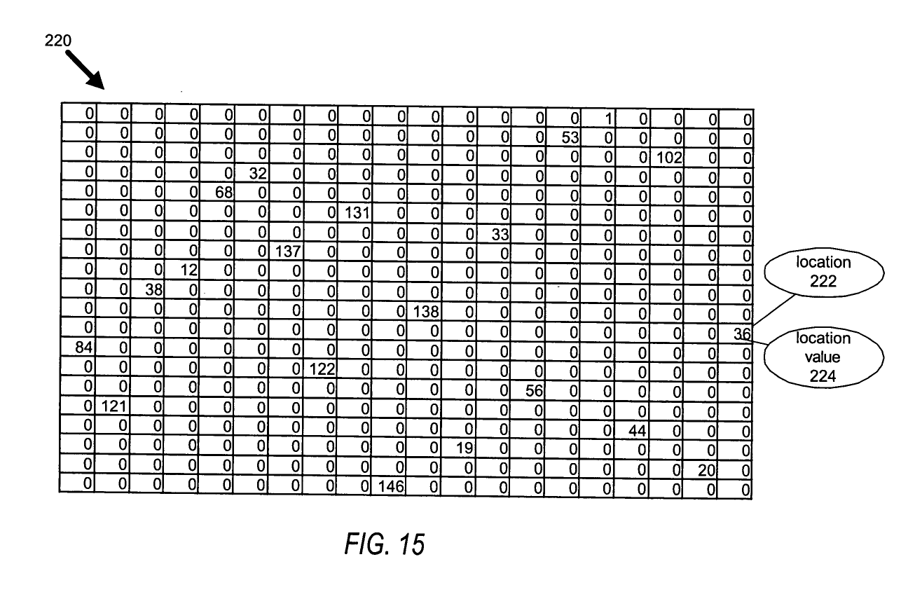

In order to facilitate a more rapid processing of the image 210 in the semi-random region 42 combining state, it is useful to have the relative locations of all of the regions 42 defined in some type of graph structure. In a preferred embodiment, a graph is simply a 2-dimensional representation or chart of the region locations where the locations in the graph are dictated by the adjacency of one region 42 to the other. A chart 220 is disclosed in FIG. 15. The chart 220 includes a location 220 for each pixel 44 in the image. In each location 222 is a location value 224. The location value 224 is zero unless that particular location 224 is the centroid for an image region 42.

The creation of the graph 42 allows the combination processing at 130 to occur more quickly. As discussed below, the system 20 can quickly drop from consideration, all the regions 42 that reside on the periphery of the image 40 or any other possible heuristic that will aid in selecting regions 42 to combine for the particular application invoking the system 20.

F. Image Region Combination

Returning to the process flow in FIG. 6, the various image regions 42 are combined at 130. A wide variety of different combination heuristics can be performed by the system 20. In a preferred vehicle safety restraint embodiment, the system 20 performs a semi-random region combination heuristic.

Complete randomness in region combining can be computationally intractable and is typically undesirable. For example, if the user is performing a database query for a particular object, a minimum size of the object can be defined as part of the query. For fully automated embodiments, the context of the application can be used to create predefined combination rules that are automatically enforced by the system 20.

In an automotive airbag suppression embodiment of the system 20, the target (the occupant of the seat) cannot be smaller than a small child, so any combination of regions 42 that are smaller than a small child are automatically dropped. Since the size of each region 42 is stored in the graph 220 of FIG. 15, it is very easy to define a minimum object size for which the system 20 can quickly determine if a given region 42 is possible. Also the use of the graph 220 allows the system 20 to randomly remove border regions 42 first in any desired combination and then continue to remove region 42 more towards the interior (an exterior removal heuristic). For an application of automotive occupant classification the total number of regions 42 is typically between 10 and 20. Clearly 2^{N} possible combinations would be impossible in a real-time system 20 so the system 20 can successfully reduce this to on the order of 2*N to N² possible combinations given an exterior heuristic search. Other applications can include similar context-specific heuristics to make the combination phase perform in a more tractable and efficient manner.

G. Classify the Combination of Image Regions

Returning to the process flow of FIG. 6, each combination of regions 42 can be then classified by the system 20 at 132. Unlike other segmentation processes, the system 20 incorporates a classification process into the segmentation process, mimicking to some degree the way that human beings will use the context of what is being viewed in distinguishing one object in an image from another object in an image

The classification of the region combinations can be accomplished through any of a number of possible classification heuristics. Two preferred methods are: (1) a Parzen Window-based distribution estimation followed by a Bayesian classifier and; (2) a k-Nearest Neighbors (“k-NN”) classifier. These two methods are desirable because they do not assume any underlying distribution for the data. For the automotive occupant classification system, the occupants can be in so many different positions in the car that a simple Gaussian distribution (for use with a Bayes classifier for example) may not be not feasible.

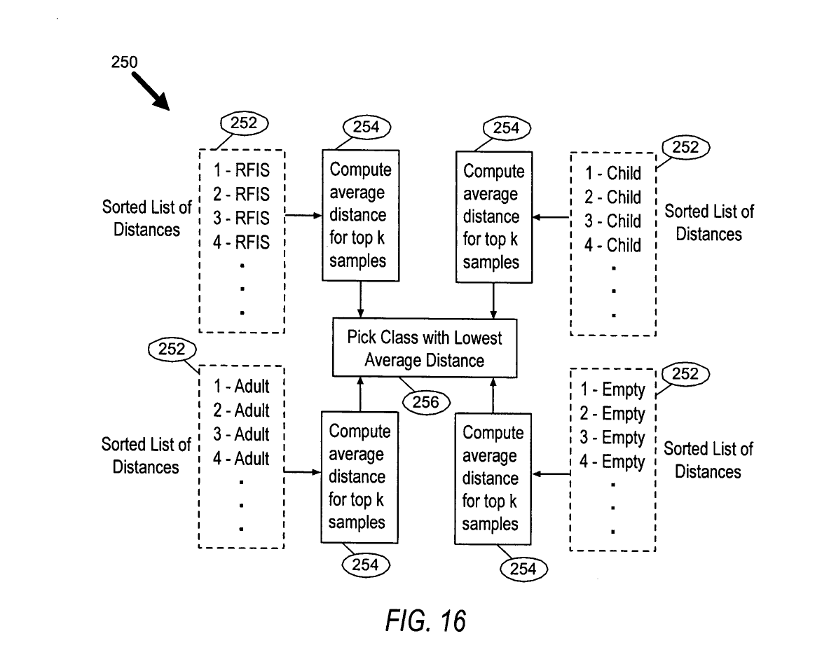

FIG. 16 is a block diagram illustrating an example of a k-Nearest Neighbor heuristic (“k-NN heuristic”) 250 that can be performed by the classification subsystem 102 discussed above. The computer system 20 performing the classification process can be referred to as a k-NN classifier. The k-Nearest Neighbor heuristic 250 is a powerful method that allows highly irregular data such as the occupant data to be classified according to what the region configuration is closest to in shape. The system 20 can be configured to use a variety of different k-NN heuristics 250. One variant of the k-NN heuristic 250 is an “average-distance k-NN” heuristic, which is the heuristic disclosed in FIG. 16.

The average-distance k-NN heuristic computes the average distance of the test sample to the k-nearest training samples in each class 38 in an independent fashion. The final decision is to choose the class 38 with the lowest average distance to its k-nearest neighbors. For example, it computes the mean for the top “k” RFIS (“rear facing infant seat”) training samples, the top k adult samples, and so on and so forth for all classes 38, and then chooses the class 38 with the lowest average distance.

The average-distance k-NN heuristic 250 is typically preferable to a standard k-NN heuristic 250 in an automotive safety restraint application embodiments, because the output is an “average-distance” metric allows the system 20 to order the possible region 42 combinations to a finer resolution than a simple m-of-k voting result, without requiring the system 29 to make k too large. The average-distance metric can then be used in subsequent processing to determine the overall best segmentation and classification.

The attribute types 34 used for the classifier are preferred to be variations on the geometric moments of the region 42 combination. Attribute types 34 can also be referred to as features. Geometric moments are calculated in accordance with Equation 1.

$${M}_{mn} = {\sum }_{j = 0}^{N} {\sum }_{i = 0}^{M} I ( i , j ) \cdot {i}^{m} \cdot {j}^{n} \qquad Equation 1$$

The system 20 can be configured to considerably accelerate the processing speed (reducing processing time) of the segmentation process by pre-computing the moments for each region 42 and then computing the moments using only local image neighborhood around each region 42.

Such a “speedup” works because the moment calculation is linear in terms of the pixels 44 used. Therefore, rather than compute the summations in Equation 1 over the entire image 26 the system 20 only needs to compute them over certain regions 42. The system 20 can record the maximum and minimum start pixels 44 in the row and column indices for each region 42 and then compute the basic geometric moments according to Equation 2.

$${M}_{mn} = {\sum }_{j = min\_j}^{max\_j} {\sum }_{i = min\_i}^{max\_i} I ( i , j ) \cdot {i}^{m} \cdot {j}^{n} \qquad Equation 2$$

Some embodiments of system 20 do not incorporate the “speedup” process, but the process is desirable because it considerably reduces the processing load required by the ratio of Equation 3:

$$speedup = \frac{N * M}{( max\_j - min\_j ) * ( max\_i - min\_i )} \qquad Equation 3$$

### For a 20×20 region extracted from a 80×100 image 40, failure to perform “speedup” can increase processing results (and processing time) by a factor of 20:1.

The system 20 can also include a second speedup mechanism in addition to the “speedup” process discussed above. The second speedup mechanism is likewise related to the linearity of the moment processing. Rather than compute the resultant combined region 42 and then compute its moments, the system 20 can just as easily pre-compute the moments and then simply add them together as the system 20 combines N_{regions} regions 42 according to Equation 4.

$${M}_{mn} = {\sum }_{k = 1}^{{N}_{regions}} \{ {\sum }_{j = {min\_j}_{k}}^{{max\_j}_{k}} {\sum }_{j = {min\_i}_{k}}^{{max\_i}_{k}} I ( i , j ) \cdot {i}^{m} \cdot {j}^{n} \} \qquad Equation 4$$

For each possible region 42 combination, the system 29 need only add the feature (attribute value 36) vectors for all of the regions 42 together to compute the final Legendre moments. This allows the system 20 to very rapidly try different combinations of regions with a processing burden that is only linear in the number of regions 42 rather than linear in the number of pixels 44 in the image 40. For a 80×100 image 40, if we assume there are 20 regions 42, then this results in a speed-up of 400:1 for each moment calculated. This improvement will allow the system 20 to try many more region 42 combinations while maintaining a real-time update rate.

To facilitate the second form of speedup processing, the region 42 configuration is presented to the classifier, and then the region 42 is turned into a binary representation (e.g. “binary region”) where any pixel 44 that is in a region becomes a 1 and all others (background) become a 0. The binary moments of some order are calculated and the features that were identified during off-line “training” (e.g. template building and testing) as having the most discrimination power are kept to keep the feature space to a manageable size.

H. Select the Best Classification/Segmentation as Output

In a preferred embodiment of the system 20, the process of region combination at 130 and combination classification at 132 is performed multiple times for the same initial ambient image 26. In such embodiments, the system 20 can then select the “best” region 42 combination as the segmented image 30. The combination evaluation heuristic used to determine which combination of regions 42 is “best” will depend to some extent of the context of the application that invokes the system 20. That selection process is performed at 134, and should preferably incorporate some type of accuracy assessment (“accuracy metric”) relating to the classification created at 132. In a preferred embodiment, the accuracy metric is a probability value. In a preferred embodiment, the highest classification probability is the “best” combination of regions 42, and that combination is exported as the segmented image 30 by the system 20. As each region 42 is added to the combined region 42, the classification distance is recomputed.

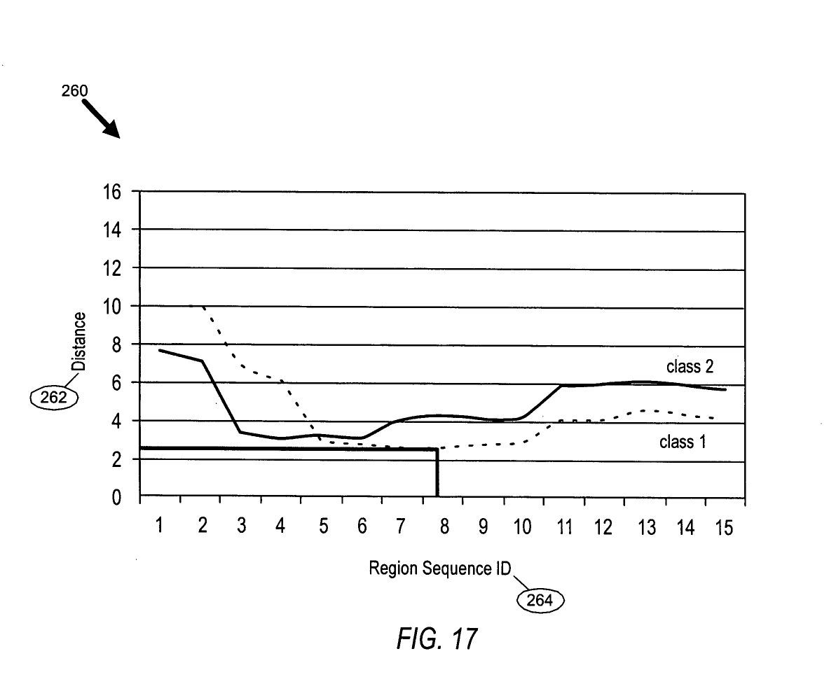

FIG. 17 is an example of a classification-distance graph 260. In the example disclosed in the figure, the y-axis of the classification-distance graph 260 is a distance metric 262 and the x-axis is a progression of region sequence IDs 264. Only two classes 38 are illustrated in the example, however the system 20 can accommodate a wide variety of different classification 38 configurations involving a wide number of different classes 38. The curve with the smallest distance 262 can be selected as the appropriate classification 38. The segmentation is defined by which region sequence ID number 264 corresponds to that minimum distance 262. In the example provided in FIG. 17, the straight unbroken lines pointing to the global minimum point (the distance 262 is just over 2 where the region sequence ID 264 is 8) show the best classification 38 and the index for identifying the best combination of regions 42 to be used as the segmented image 30. The region sequence ID 264 is the identification of the number of regions 42 that have been sequentially included in the segmentation process. By maintaining a linked list of the specific region sequence IDs 264, the segmentation process can be reconstructed for the desired region sequence ID 264, resulting in the segmented image 30.

### V. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A method for segmenting a target image from an ambient image, comprising:
categorizing the ambient image into a plurality image regions on the basis of image constancy; and
combining a subset of the image regions together into the target image in accordance with a predefined combination heuristic.

2. The method of claim 1, wherein the ambient image is the latest image in a sequence of ambient images.

3. The method of claim 1, wherein the target image includes characteristics of a human occupant in a vehicle, and wherein the target image is used to make deployment decisions for a safety restraint application in the vehicle.

4. The method of claim 1, further comprising removing a subset of areas from the ambient image that are not of interest.

5. The method of claim 4, wherein the subset of areas are removed from the ambient image before the categorization of the ambient image.

6. The method of claim 4, wherein areas of the ambient image that are substantially identical in a series of ambient images are removed from the ambient image.

7. The method of claim 1, further comprising calculating parameter values describing image constancy.

8. The method of claim 7, wherein the parameter values include at least one of a color value, a texture value, and a grayscale value.

9. The method of claim 7, wherein an expectation-maximization heuristic calculates the parameter values.

10. The method of claim 1, wherein the categorizing of the ambient image includes filtering the image regions to remove noise.

11. The method of claim 1, wherein the categorizing of the ambient image includes ignoring image regions smaller than a predetermined threshold.

12. The method of claim 1, further comprising storing information relating to at least two of a centroid location, a number of pixels, a maximum coordinate value, and a minimum coordinate value.

13. The method of claim 1, further comprising identifying the locations of some image regions on a graph.

14. The method of claim 1, further comprising selectively removing image regions on the basis of the location characteristics relating to the removed image regions.

15. The method of claim 1, wherein the predefined combination heuristic includes trying every possible combination of combined image regions that have not previously been excluded.

16. The method of claim 1, further comprising classifying the subset of image regions.

17. The method of claim 16, further comprising calculating a probability associated with the particular classification.

18. The method of claim 16, wherein an underlying data distribution is not assumed.

19. The method of claim 16, wherein a Parzen Window-based heuristic is performed to classify the subset of image regions.

20. The method of claim 16, wherein a k-nearest neighbor heuristic is invoked to classify the subset of image regions.

21. A method for segmenting a target image from an ambient image in a sequence of images, comprising:
identifying areas of interest in the ambient image;
estimating parameters representing image constancy for the areas of interest;
selectively grouping pixels in the areas of interest into image regions on the basis of the estimated parameters representing image constancy;
defining the relative locations of the image regions; and
selectively combining image regions together into the target image.

22. The method of claim 21, wherein the ambient image is an interior vehicle area that includes an occupant, and wherein the target image includes the upper torso of the occupant.

23. The method of claim 21, further comprising classifying the target image without assuming an underlying distribution.

24. The method of claim 21, creating a histogram of estimated parameters to selectively group pixels into image regions.

25. The method of claim 21, further comprising removing image regions from subsequent processing on the basis of size.

26. An image processing system for use with the safety restraint application of a vehicle, comprising:
a segmentation subsystem, including an ambient image, and a plurality of image regions, wherein said segmentation subsystem provides for the identification of said plurality of image regions from said ambient image; and
a classification subsystem, including a segmented image, wherein said segmentation subsystem provides for the selective combination of a subset of image regions into said segmented image.

27. The system of claim 26, further comprising an analysis subsystem, said analysis subsystem including an occupant characteristic, wherein said analysis subsystem provides for the capture of said occupant characteristic from said segmented image, and wherein said analysis subsystem provides for the transmission of said occupant characteristic to the safety restraint system of the vehicle.

28. The system of claim 27, wherein said occupant characteristic is an occupant classification.

29. The system of claim 26, further comprising a plurality of pixels, wherein said ambient image includes said plurality of pixels, and wherein said system provides for the removing of a subset of pixels in said ambient image from consideration as pixels in said segmented image.

30. The system of claim 29, wherein the removed subset of pixels are not identified as belonging to a region of interest.

31. The system of claim 29, wherein the removed subset of pixels are associated with at least one said image region selectively identified by comparison with a size threshold.

32. The system of claim 29, wherein an exterior first heuristic is performed to remove the subset of pixels.

33. The system of claim 26, said segmentation subsystem further including a plurality of parameter types and a plurality of parameter values, wherein said parameter values associated with said parameter types are used to categorize a plurality of pixels within an ambient image into said plurality of image regions.

34. The system of claim 33, wherein said classification subsystem performs an expectation-maximization heuristic using said parameter values.

35. The system of claim 33, said classification subsystem further including a histogram of said pixels and said parameter values.

36. The system of claim 33, said classification subsystem further including a representation comprising a plurality of image region locations, wherein said classification subsystem uses said representation to facilitate the selective combination of said subset of image regions into said segmented image.

37. The system of claim 26, wherein said classification subsystem includes a classification heuristic that does not assume an underlying distribution.

38. The system of claim 37, wherein the classification heuristic is one of a Parzen Window heuristic and a k-nearest neighbor heuristic.

39. The system of claim 26, wherein said occupant characteristic relates to the location of the upper torso of the occupant.

40. The system of claim 26, wherein said occupant characteristic is used to make an at-risk-zone determination.

41. The system of claim 26, wherein said occupant characteristic is used to make an occupant type determination.
